(19) United States
(12) Patent Application Publication
(10) Pub. No.: US 2017/0273164 A1
(43) Pub. Date: Sep. 21, 2017

(54) SYSTEMS, METHODS, AND DEVICES FOR INTELLIGENT LIGHTING CONTROL

(71) Applicant: Magnitude Holdings Ltd., Hamilton (BM)

(72) Inventor: Ehud Kirmayer, Hulda (IL)

(21) Appl. No.: 15/461,048

(22) Filed: Mar. 16, 2017

Related U.S. Application Data
(60) Provisional application No. 62/309,157, filed on Mar. 16, 2016.

(51) Int. Cl. H05B 37/02; H05B 33/08

(52) U.S. Cl. CPC H05B 37/0272; H05B 33/0845; H05B 33/0812

(57) ABSTRACT

A lighting control system is disclosed including a microcontroller that can receive multiple luminaire control inputs in various protocols, output multiple luminaire control outputs. The luminaire control inputs and luminaire control outputs can be in various protocols and interfaces, and the microcontroller can also determine a hierarchy for the luminaire control inputs and outputs. The hierarchy allows the microcontroller to receive multiple luminaire control inputs and output the appropriate control to a luminaire or a number of luminaires. The hierarchy also determines which protocol or luminaire control input takes priority when multiple inputs are received. The hierarchy can be set or updated by a user via an electronic device. The microcontroller receives the luminaire control inputs via a first interface, and a second interface transmits the luminaire control outputs from the microcontroller.

### RELATED APPLICATIONS

This application claims priority to U.S. Provisional Application No. 62/309,157 filed on Mar. 16, 2016, the contents of which is hereby incorporated by reference in its entirety.

### BACKGROUND

Various lighting systems may use different lighting protocols for dimming and controlling the state (on/off) of one or more luminaires.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of an exemplary lighting control system, according to embodiments of the present disclosure.

FIG. 2 is a block diagram of an exemplary lighting control system including a dongle and socket, according to embodiments of the present disclosure.

FIG. 3 is a block diagram of an exemplary lighting control system including a phase-cut dimmer, according to embodiments of the present disclosure.

FIG. 4 is a block diagram of an exemplary lighting control system including a phase-cut dimmer, according to other embodiments of the present disclosure.

FIG. 5 is a block diagram of an exemplary lighting control system including a phase-cut dimmer, according to other embodiments of the present disclosure.

FIG. 6 is a flowchart illustrating an exemplary method for controlling input to an LED driver, according to embodiments of the present disclosure.

FIG. 7 is a diagram of an exemplary network environment suitable for a distributed implementation of an exemplary embodiment.

### DETAILED DESCRIPTION

According to exemplary embodiments of the present invention, systems, methods, and devices are disclosed for receiving a plurality of luminaire control inputs in various protocols, outputting a plurality of luminaire control outputs in various protocols, and determining a hierarchy within those protocols.

As discussed herein, a luminaire can include, for example, an LED lamp, an LED driver, an incandescent lamp, a fluorescent lamp, or any other type of lighting module.

Conventional dimming controllers, such as controllers available from Casambi Technologies of Finland, allow control of the 0-10V dimming of a luminaire, and thus luminaire dimming, via Bluetooth Low Energy (BLE) lighting control. However, in order to turn the luminaire on or off, a wall switch is required. Furthermore, such controllers merely act as an interface between one control protocol to another—in this example BLE to 0-10V.

In one exemplary embodiment, a lighting controller is disclosed that can receive BLE control input, 0-10V control input, 1-10V control input, or other luminaire control inputs. For example, the lighting controller can be configured to receive lighting control commands via WiFi, Bluetooth, WiMAX, ZigBee, RS-232, Serial Peripheral Interface (SPI), RS-485, global system for mobile communications (GSM), general packet radio service (GPRS), or some other wireless communication protocol. The lighting controller can include a wireless communication module that is capable of receiving communication signals in these and additional communication protocols. In some embodiments, a user can transmit wireless lighting control commands to the lighting controller using a mobile electronic device or some other electronic device associated with the user. The lighting controller can also receive lighting control commands from a 0-10V lighting dimmer and/or a phase-cut dimmer. The controller can then control one or more luminaires using the wireless control input, the phase-cut dimmer input, and/or 0-10V input. In some embodiments, the controller can access a hierarchy list in order to determine which protocol or luminaire control input takes priority when multiple inputs are received. For example, if BLE, 0-10V, 1-10V, and WiFi inputs are received, the controller can execute an algorithm to determine input priority and then output the desired lighting command to a luminaire or several luminaires. The controller can also execute an algorithm to implement different dimming levels for each luminaire according to preset scenarios or conditions. The controller can also include or be coupled to a relay switch to allow the luminaire to be turned on or off via control inputs in addition to a wall switch and, in some embodiments, without the need for a separate on/off switch. Each of the embodiments discussed below can be implemented with an isolated luminaire including a transformer or a non-isolated luminaire without a transformer.

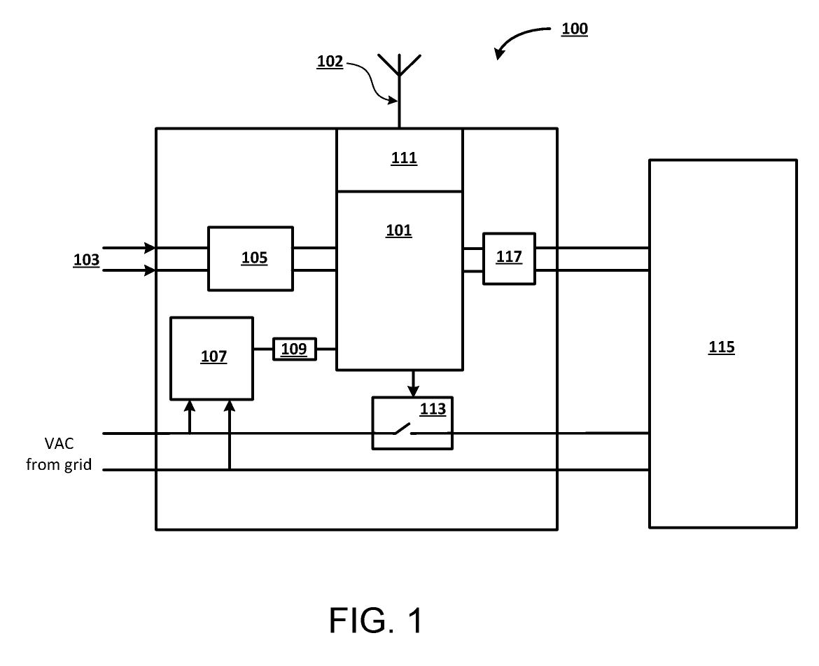

FIG. 1 is a block diagram of an exemplary lighting control system 100 according to embodiments of the present disclosure. In this embodiment, a microcontroller 101 is able to receive input commands from a number of different sources, determine a hierarchy among those sources, and appropriately control a luminaire or a number of luminaires. In exemplary embodiments, the microcontroller 101 can receive a 0-10V control input 103 from a dimmer through a first analog interface 105. The first analog interface 105 can be, for example, an analog to digital converter that converts continuous analog signals, such as a signal from a 0-10V dimmer, to into digital signals that can be input to the microcontroller. In exemplary embodiments, the microcontroller 101 can include, for example, an integrated circuit that has one or more processors and memory. The microcontroller 101 receives its Vcc input via an AC/DC power supply 107 that can receive its input from an AC power grid, in some embodiments. The AC/DC power supply may drive a linear DC voltage regulator, for example, a low dropout regulator 109. In other embodiments, the microcontroller 101 can be powered from a battery. In some embodiments the microcontroller 101 can also receive inputs via an RF interface 111 (BLE, WiFi, etc.) that can be in communication with an antenna 102 configured to receive radio waves. The microcontroller 101 can also be operatively coupled to a single switch 113 to make or break a line feed to an LED or luminaire driver 115, such that the microcontroller 101 can provide a control signal to open and close the switch 113 to turn the driver 115 on or off. A second analog interface 117 between an output of the microcontroller 101 and a control input of the driver 115 can be used to send appropriate luminaire control commands to the driver 115, for example, 0-10V dimming control signals. In some embodiments, the second analog interface 117 includes a digital to analog converter that is configured to receive digital signals from the microcontroller and convert them into analog signals, such as 0-10V dimming control signals, that can be applied to the driver 115. In exemplary embodiments, the control system can output more than one control signal in order to control two or more luminaires at the same time.

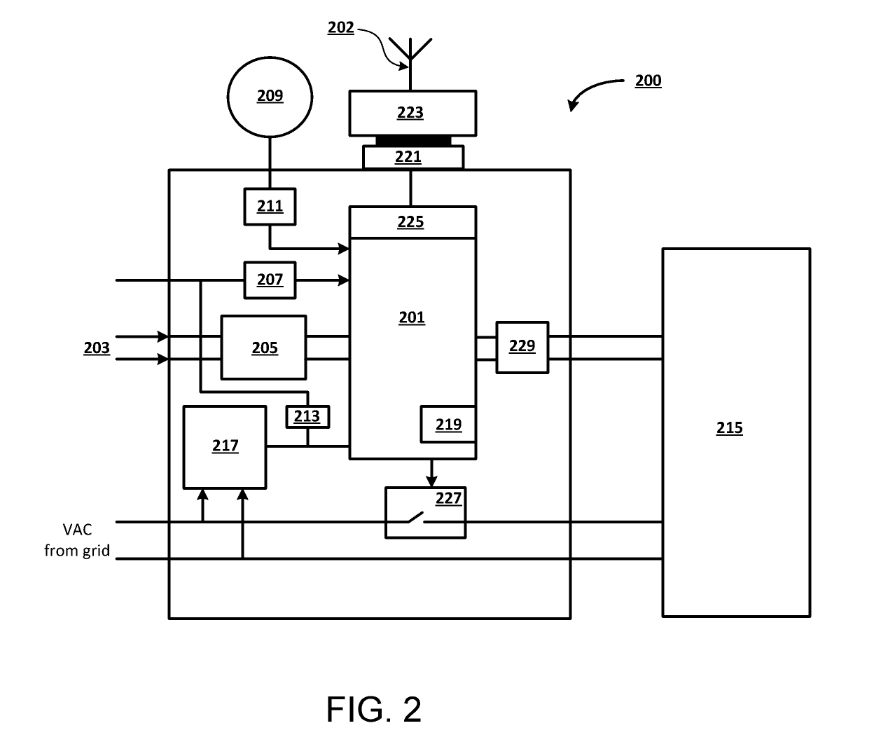

FIG. 2 is a block diagram of an exemplary lighting control system 200 according to embodiments of the present disclosure. In this embodiment, a microcontroller 201 is able to receive input commands from a number of different sources, determine a hierarchy among those sources, and appropriately control a luminaire via a driver 215. In some embodiments, the hierarchy of input commands can be configured by a user via an online account or an application running on a mobile electronic device. For example, the user can decide that when multiple input commands are received at the microcontroller, the control signals received from a 0-10V wall dimmer will take priority over commands received via Bluetooth or WiFi from a mobile electronic device or some other wireless signal source. The driver 215 can include, for example, an electrical device that regulates power to a luminaire, such as an LED, or a string of luminaires. Regulating power to an LED or string of LEDs is important to prevent the LEDs from drawing too much power and burning out. The microcontroller 201 can receive a 0-10V control input 203 from a dimmer or a lighting control system through a first analog interface 205 or a pulse-width modulation (PWM) interface configured to receive a PWM signal. The first analog interface 205 can be, for example, an analog to digital converter that converts continuous analog signals, such as a signal from a 0-10V dimmer, to into digital signals that can be input to the microcontroller. In some embodiments, the microcontroller 201 can receive an Ethernet packet input with control instructions in the payload over an Ethernet interface or a Power-Over-Ethernet (POE) interface 207. The microcontroller 201 can also receive control input from various sensors 209, in some embodiments, through a second analog interface 211 configured to receive analog inputs from the sensors and convert these signals into digital signals that can be input to the microcontroller 201. The various sensors 209 may include, for example, light sensors, movement sensors, smoke detectors, thermostats, etc. In some example embodiments, the microcontroller 201 may also receive power through a Low-Dropout (LDO) voltage regulator 213 via the POE connection. The microcontroller 201 may receive its Vcc input via an AC/DC power supply 217 that can be powered by via an AC grid, in some embodiments. In some embodiments the microcontroller 201 includes a real-time clock 219 that can be used to help implement certain lighting schedules or apply time-dependent lighting configuration parameters. The microcontroller can also include a driver socket 221 to receive a removable wireless communication dongle 223, such as a USB WiFi dongle. The microcontroller 201 is able to communicate with the dongle 223 and receive commands and instructions therefrom. The dongle 223 can include, for example, a WiFi dongle that can couple to the control system via a USB interface. In other embodiments, the dongle 223 can include an I²C interface, RS-232 interface, or any other interface dongle. The microcontroller 201 can also can also receive inputs via an RF interface 225 (BLE, WiFi, etc.) that can be in communication with an antenna 202 configured to receive radio waves. In some embodiments, the RF module can be a group of devices including a WiFi dongle, Bluetooth device, cellular device, sub-GHz device, etc. The microcontroller 201 can also be operatively coupled to a switch 227, such that the microcontroller 201 can provide a control signal to open and close the switch 227 to turn the luminaire driver 215 on or off. In some embodiments, a third analog interface 229 between one output of the microcontroller 201 and one control input of the luminaire driver 215 can be used to send appropriate command inputs to the driver 215, for example, 0-10V dimming control signals. In some embodiments, the third analog interface 229 includes a digital to analog converter that is configured to receive digital signals from the microcontroller and convert them into analog signals, such as 0-10V dimming control signals, that can be applied to the driver 215. In exemplary embodiments, the same interface can also be used for PWM digital control.

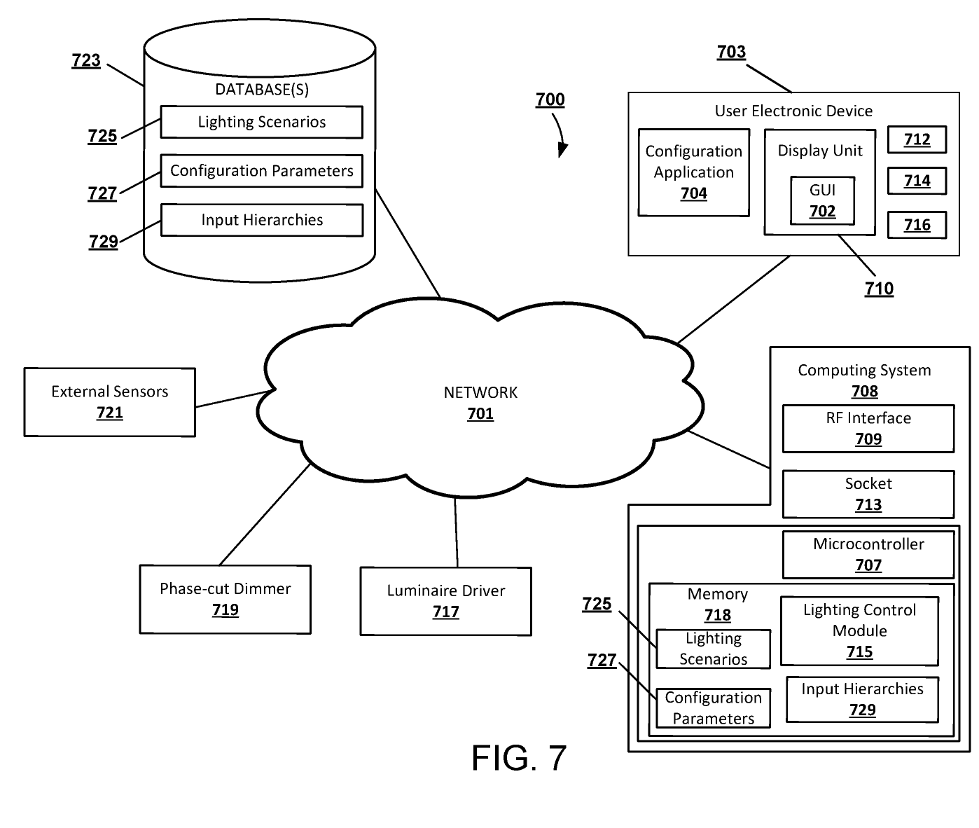

In one exemplary embodiment, the microcontroller 201 of FIG. 2 can receive lighting control commands from various sources, such as 0-10V dimmer, BLE dimmer, WiFi dimmer, a removable dongle dimmer, etc. The microcontroller 201 can receive commands from any one of these sources, and execute an algorithm to determine a hierarchy among the inputs. In some exemplary embodiments, a user can set or alter the hierarchy using a computer, mobile device, or some other electronic device in communication with the microcontroller 201 or the lighting control system. The hierarchy can also be set using on board switches or jumpers. In some examples, the user can interact with a user interface on an electronic device, such as a touch-screen mobile device, or an RF dimmer in order to send lighting control commands to the microcontroller 201 in order to control the intensity of various luminaires. In some embodiments, the user can interact with a graphical user interface (GUI) such as the GUI described in reference to FIG. 7, in order to set configuration parameters, determine lighting scenarios, and set input hierarchies. The user can create a personalized or public account with customizable light settings, input hierarchies, lighting scenarios, configuration parameters, etc. The various light settings can determine, for example, which light elements should be controlled, which inputs should receive priority if multiple inputs are received, luminaire groups, etc. The microcontroller can also implement lighting schedules or lighting scenarios based on a calendar or timeline, in addition to receiving user input. For example, certain lighting scenarios may be applied to particular times of day in order to provide optimized light settings. In some embodiments, an evening lighting scenario can ensure that the lights are not too bright in the evenings. In other embodiments, a particular lighting scenario or configuration parameter can be activated in an office building during working hours in order to provide the best light level to reduce eye strain. Once the appropriate hierarchy has been set, the microcontroller 201 can generate and transmit the appropriate luminaire control output command to the driver 215 of the luminaire or luminaires via the interface coupled to the output or outputs of the microcontroller 201. The luminaire control output command can be configured to control one or more luminaires, such as an LED or a string of LEDs, to generate a desired lighting level or generate a desired lighting patter.

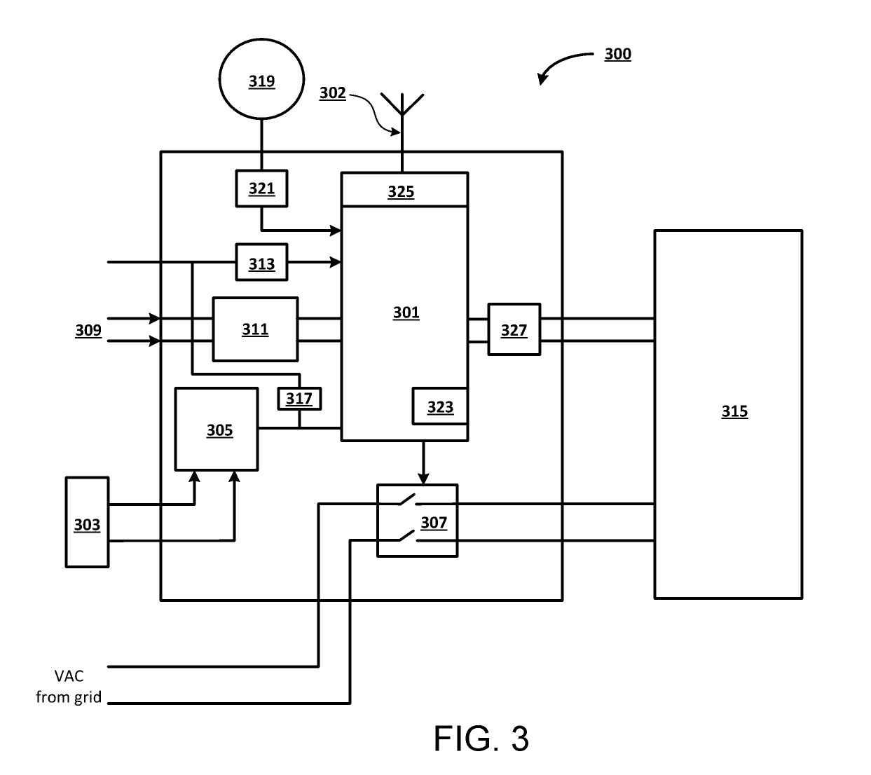

FIG. 3 is a block diagram of an exemplary lighting control system 300 including a phase-cut dimmer 303 according to embodiments of the present disclosure. In this embodiment, the lighting control system 300 includes, among other features, input nodes to receive input from the phase-cut dimmer 303. The phase-cut dimmer 303 can receive power from an AC voltage source, and the output terminals of the phase-cut dimmer 303 can be coupled to an AC/DC power supply 305 that feeds the microcontroller 301. The VAC from the grid can be coupled to the luminaire driver 315 through a relay or other controlled switch 307 such as a Triac or a Solid State Relay without supplying power to the AC/DC power supply 305. In this embodiment, the phase-cut dimmer 303 controls the RMS value of the VAC input to the luminaire driver 315 and provides a maximum limit to the possible light intensity of the luminaire. For example, if the phase-cut dimmer 303 is set such that the maximum possible luminaire light intensity will be 70% and a 0-10V input is requesting 50% light intensity, the output to the luminaire will be set to 50%. However, because the phase-cut dimmer 303 provides a maximum limit to the system, if the phase-cut dimmer 303 is set to 70% light intensity and a 0-10V input is requesting 100% light intensity, the microcontroller 301 output to the luminaire will be set to 70%. A separate switch can be used to control on and off of the luminaire driver 315, in some embodiments.

In addition to the input from the phase-cut dimmer 303, the microcontroller 301 can also receive various input command signals 309 or control inputs through a first analog interface 311 that can be configured to receive continuous analog command signals 309 from a number of analog signal sources and convert them to digital signals that can be provided to the microcontroller 301. These command signals 309 can include 0-10V signals, Digital Addressable Lighting Interface (DALI) signals, or other command signals in various communication protocols. In some embodiments, the microcontroller 301 can also receive an Ethernet packet input with control instructions in the payload over an Ethernet interface or a POE interface 313. In some embodiments, the microcontroller 301 can receive power through an LDO voltage regulator 317 via the POE interface. The microcontroller 301 can also receive control inputs from various sensors 319 through a second analog interface 321 configured to receive analog inputs from the sensors 319 and convert these signals into digital signals that can be input to the microcontroller 301. The various sensors 319 can include, for example, light sensors, motion sensors, smoke detectors, thermostats, carbon monoxide sensors, etc. In some embodiments, the microcontroller includes a real-time clock 323, and can include an RF interface 325 configured to receive wireless control signals, such as BLE, WiFi, global system for mobile communications (GSM), general packet radio service (GPRS), ZigBee, or other wireless communication signals. The RF interface 325 can receive wireless signals using, for example, an antenna 302 configured to receive radio waves. In some embodiments, a third analog interface 327 between an output of the microcontroller 301 and an input of the driver 315 can be used to send appropriate command inputs to the driver 315, for example, 0-10V dimming control signals.

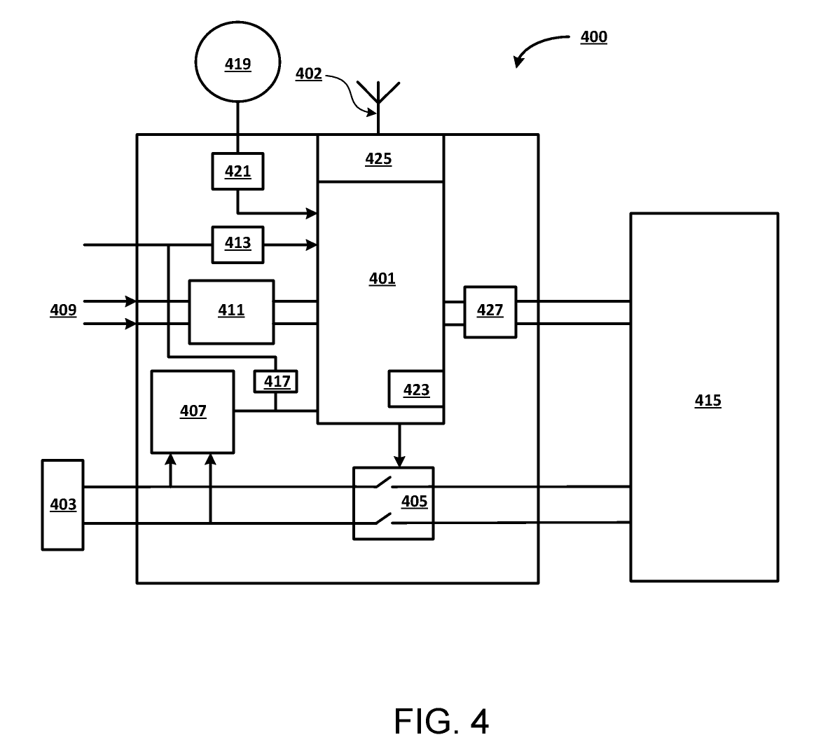

FIG. 4 is a block diagram of an exemplary lighting control system 400 including a phase-cut dimmer 403 according to another embodiment of the present disclosure. In this embodiment, the lighting control system 400 includes inputs to allow the phase-cut dimmer 403 to control dimming of the luminaire as well as control on and off of the luminaire. In this embodiment, the phase-cut dimmer 403 controls the dynamic range of the system. For example, if the phase cut dimmer 403 is set to 50%, and a 0-10V input is requesting 100% brightness, the output of the luminaire is 50% brightness. However, because the phase-cut dimmer 403 controls the dynamic range of the system, if the phase-cut dimmer 403 is set to 50% and the 0-10V input is requesting 50% brightness, the luminaire brightness is 25%. This is because the phase cut dimmer 403 is coupled to the luminaire to provide VAC to the driver 415 through a switch 405. The phase-cut dimmer 403 can receive power from an AC voltage source, in some embodiments, and the output terminals of the phase-cut dimmer 403 can be coupled to an AC/DC power supply 407 that is feeding the microcontroller 401.

In addition to the input from the phase-cut dimmer 403, the microcontroller 401 can also receive various input command signals 409 through a first analog interface 411. These command signals 409 can include 0-10V signals, DALI signals, or other command signals in various communication protocols. In some embodiments, the microcontroller 401 can also receive an Ethernet packet input with control instructions in the payload over an Ethernet interface or a POE interface 413. In some embodiments, the microcontroller 401 can receive power through an LDO voltage regulator 417 via the POE interface. The microcontroller 401 can also receive control inputs from various sensors 419 through a second analog interface 421. The various sensors 419 can include, for example, light sensors, motion sensors, smoke detectors, thermostats, carbon monoxide sensors, etc. In some embodiments, the microcontroller includes a real-time clock 423, and can include an RF interface 425 configured to receive wireless control signals, such as BLE, WiFi, GSM, ZigBee, or other wireless communication signals. The clock 423 can be used to help implement certain lighting schedules or apply time-dependent lighting configuration parameters, and the RF interface 425 can receive wireless signals via an antenna 402. In some embodiments, a third analog interface 427 between an output of the microcontroller 401 and an input of the driver 415 can be used to send appropriate command inputs to the driver 415, for example, 0-10V dimming control signals.

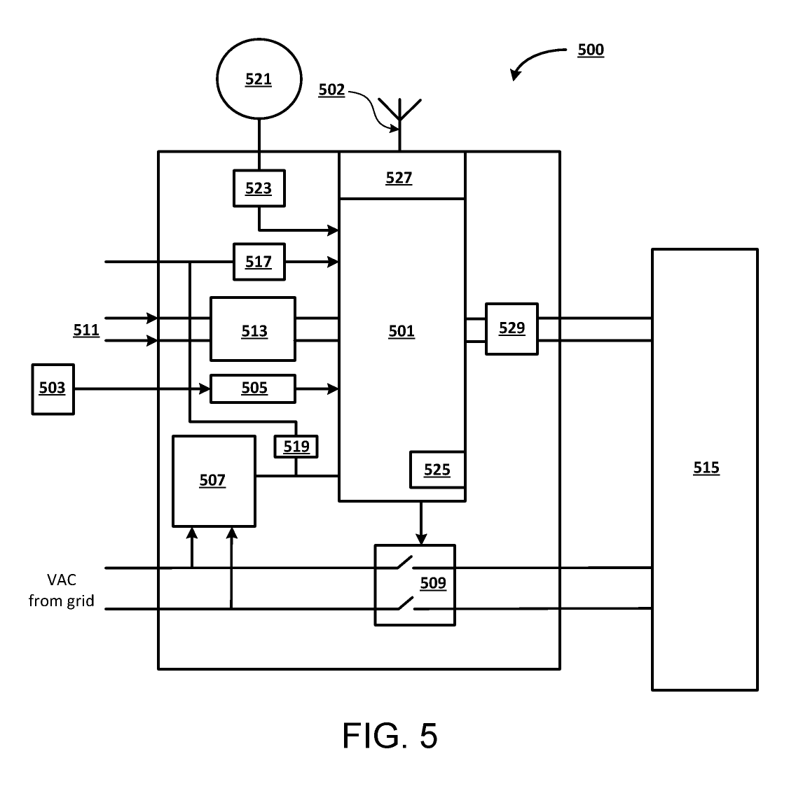

FIG. 5 is a block diagram of an exemplary lighting control system 500 including a phase-cut dimmer 503 according to another embodiment of the present disclosure. In this embodiment, the lighting control system 500 includes inputs coupled to a phase-cut dimmer 503 through a phase-cut interface 505. In this embodiment, the phase-cut dimmer 503 is not used to provide VAC to the luminaire driver 515 or to the AC/DC power supply 507. Instead, the phase-cut dimmer 503 is coupled to the microcontroller 501 through the phase-cut interface 505 to provide yet another dimming protocol. The phase-cut dimmer 503 can receive power from an AC voltage source, in some embodiments, and the phase-cut interface 505 can receive control signals from the phase-cut dimmer 503 and convert those signals into digital signals that can be provided to the microcontroller 501. The phase-cut dimmer 503 does not turn the luminaire on or off, or provide a limit or dynamic range for the lighting system. The luminaire driver 515 can receive power from the grid through a relay or other controlled switch 509 such as a Triac or a solid state relay. The AC/DC power supply 507 can also receive power from the grid.

In addition to the input from the phase-cut dimmer 503, the microcontroller 501 can also receive various input command signals 511 through a first analog interface 513. These command signals 511 can include 0-10V signals, DALI signals, or other command signals in various communication protocols. In some embodiments, the microcontroller 501 can also receive an Ethernet packet input with control instructions in the payload over an Ethernet interface or a POE interface 517. In some embodiments, the microcontroller 501 can receive power through an LDO voltage regulator 519 via the POE interface. The microcontroller 501 can also receive control inputs from various sensors 521 through a second analog interface 523. The various sensors 521 can include, for example, light sensors, motion sensors, smoke detectors, thermostats, carbon monoxide sensors, etc. In some embodiments, the microcontroller 501 includes a real-time clock 525, and can include an RF interface 527 configured to receive wireless control signals, such as BLE, WiFi, GSM, ZigBee, or other wireless communication signals. The clock 525 can be used to help implement certain lighting schedules or apply time-dependent lighting configuration parameters, and the RF interface 527 can receive wireless signals via an antenna 502. In some embodiments, a third analog interface 529 between an output of the microcontroller 401 and an input of the driver 515 can be used to send appropriate command inputs to the driver 515, for example, 0-10V dimming control signals.

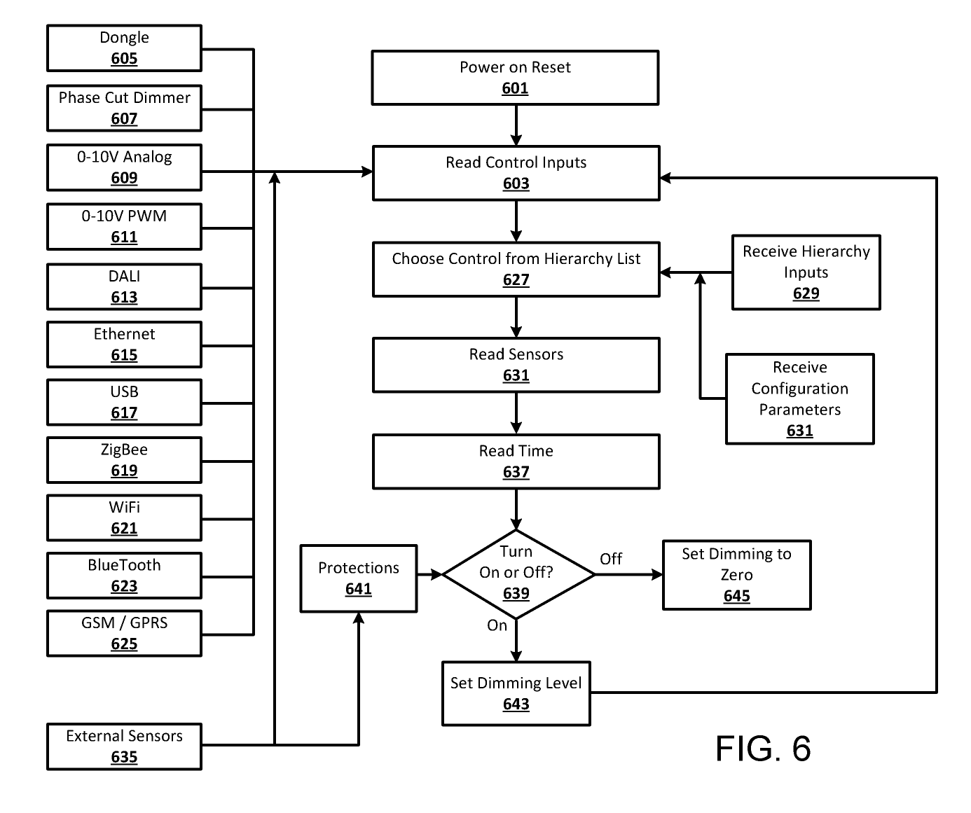

FIG. 6 illustrates an exemplary flow chart 600 for controlling input to a luminaire according to embodiments of the present disclosure. In step 601, upon a power on reset by application of power, the system and a microcontroller begin operation in a known state. Once powered on, the microcontroller can read any control inputs in step 603 that may be input to the microcontroller. Example control inputs can be provided by a dongle 605, a phase-cut dimmer 607, 0-10 Volts analog 609, 0-10 Volts PWM 611, DALI 613, Ethernet 615, USB 617, ZigBee 619, WiFi 621, Bluetooth 623, GSM/GPRS 625, etc. These control inputs can include, for example, the various control signals 309, 409, 511 discussed above in reference to FIGS. 3-5, as well as any wireless control signals received via the RF interfaces 111, 225, 325, 425, 527 discussed above. Each of these control inputs can be read by the microprocessor, which chooses the desired control based on a hierarchy or an algorithm.

In step 627, the microcontroller chooses the appropriate control input based on an input hierarchy. In some examples, the hierarchy can be user configurable. In such examples, the system can receive hierarchy inputs in step 629 from, for example, a user interface or user account. In some embodiments, the hierarchy inputs can be dynamically updated by a user via a user account, an application executed on a mobile electronic device, or some other user input technique. In step 631, the system also receives configuration parameters that can be applied to the lighting control system. Examples of configuration parameters include, for example, various lighting scenarios, protection thresholds, brightness thresholds for different times of day or night, lighting schedules, a list of allowed inputs, etc. The hierarchy and configuration parameters can be input via a GUI, such as the GUI discussed in reference to FIG. 7, using an electronic device. In some embodiments, a hierarchy for each desired scenario is input to the microcontroller. For example, one hierarchy may instruct the microcontroller to implement a BLE input as overriding 0-10 Volt analog inputs or Ethernet inputs. In such an example, if an Ethernet or 0-10 Volt analog input requests 50% brightness and a BLE input requests 70% brightness, the result is 70% brightness output to the luminaire from the microcontroller because the BLE command takes priority. Other options may include priority according to the sequence the commands arrived or any other algorithm or scenario defined or programed into the system. Additional configurable parameters may be input to the microcontroller.

In step 631, once a relevant control has been chosen from the hierarchy, data from external sensors 635 can be read before the microcontroller decides on a suitable level of light. In some exemplary embodiments, the external sensors 635 can include, for example, light sensors, motion sensors, smoke detectors, thermostats, carbon monoxide sensors, a clock, etc. In step 637, the system reads the current time in order to conform the desired level of light to any applicable lighting schedule.

In step 639, the system determines whether to turn AC power to the luminaire on or off. In some examples, various protections can be applied, in step 641, to the external sensors and can determine whether AC power is turned on or off. For example, a protection may include a command to implement a particular emergency lighting pattern if a fire or smoke detector goes off or if a security system determines that a security breach has occurred. If the AC power to the luminaire is to be turned off, the dimming may be set to zero in step 645 and the relay to the luminaire is turned off. If, however, the AC power is to be turned on, a desired dimming level is set in step 643 and the relay to the luminaire is turned on or remains on. The system can set the desired dimming level using the microcontroller to generate a luminaire control output command that can control the luminaire driver to generate the desired light dimming level. Once this control output command has been generated, it can be transmitted to the driver in order to control the luminaire. Once the desired dimming level is set in step 643, the system can again monitor the various inputs described above and receive any new control inputs in step 603.

FIG. 7 illustrates a network diagram depicting a system 700 suitable for a distributed implementation of an exemplary embodiment. The system 700 can include a network 701; a user electronic device 703; a computing system 708 including a microcontroller 707, an RF interface 709, and a socket 713; a luminaire driver 717, a phase-cut dimmer 719, a number of external sensors 721, and a database 723. The microcontroller 707 can include memory 718 configured to store lighting scenarios 725, configuration parameters 727, input hierarchies 729, and a lighting control module 725. The microcontroller can execute the lighting control module 715 in order to receive the various command signals, choose a command signal from among the received signal, generate an output command, and transmit this output command to the luminaire driver 717. As will be appreciated, various distributed or centralized configurations may be implemented without departing from the scope of the present invention. In exemplary embodiments, the computing system 708 can store and execute a lighting control module 715 which can implement one or more of the processes described herein with reference to FIG. 6, or portions thereof. It will be appreciated that the module functionality may be implemented as a greater number of modules than illustrated and that the same server or computing system could also host multiple modules. The database 723 can also store the lighting scenarios 725, configuration parameters 727, and input hierarchies 729, as discussed herein. In some embodiments, the lighting control module 715 can communicate with the RF interface 709, the phase-cut dimmer 719, the external sensors 721, the database 723, and the luminaire driver 717 in order to receive input commands and determine a hierarchy of input commands for controlling the luminaire driver 717.

In exemplary embodiments, the user electronic device 703 may include a display unit 710, which can display a GUI 702 to a user of the user electronic device 703. The user electronic device 703 can also include a memory 712, processor 714, and a wireless interface 716. In some embodiments, the user electronic device 703 may include, but is not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, smartphones, and the like.

The user electronic device 703 may connect to the network 701 via a wired or wireless connection and can be used to transmit input commands to the computing system 708 using any number of communication protocols. The user electronic device 703 may include one or more applications such as, but not limited to, a web browser. In exemplary embodiments, the user electronic device 703, computing system 708, luminaire driver 717, external sensors 721, and database 723 may be in communication with each other via the communication network 701. The communication network 701 may include, but is not limited to, the Internet, an intranet, a LAN (Local Area Network), a WAN (Wide Area Network), a MAN (Metropolitan Area Network), a wireless network, an optical network, and the like. In one embodiment, the user electronic device 703, the computing system 708, the luminaire driver 717, the external sensors 721, and the database 723 can transmit instructions to each other over the communication network 701. In exemplary embodiments, the lighting scenarios 725, configuration parameters 727, and input hierarchies 729 can be stored at the database 723 and received at the computing system 708 in response to a service performed by a database retrieval application.

In exemplary embodiments, the user can set or adjust the input hierarchies 729, lighting scenarios 725, and configuration parameters 727 using a lighting configuration application 704 running on the user electronic device 703. The configuration application 704 can be a software application executing on the user electronic device 703 and the user can interact with the configuration application 704 using the GUI 702, for example. The user can create and/or update a personalized account with customizable light settings using the configuration application 704, in some embodiments. In some embodiments, the user can transmit wireless lighting control commands to the microcontroller 707 using the configuration application 704.

Exemplary flowcharts are provided herein for illustrative purposes and are non-limiting examples of methods. One of ordinary skill in the art would recognize that exemplary methods may include more or fewer steps than those illustrated in the exemplary flowcharts, and that the steps in the exemplary flowcharts may be performed in a different order than the order shown in the illustrative flowcharts. Other communication methods and protocols may be used as well. Other means/types of analog and digital control signals to/from the controller from the user or sensors or other electrical and mechanical systems and to the luminaire can be used. The control system can be implemented by various controllers, processors and discrete logic elements other than the ones demonstrated here above.

We claim:

1. A luminaire control system comprising:
a microcontroller configured to execute a lighting control module to:
receive a plurality of luminaire control inputs;
determine a desired lighting level based on one of the plurality of luminaire control inputs;
generate a luminaire control output command configured to control a luminaire driver to generate the desired lighting level; and
transmit the luminaire control output command to the luminaire driver.

2. The system of claim 1, wherein one of the plurality of luminaire control inputs is a wireless input.

3. The system of claim 1, wherein one of the plurality of luminaire control inputs is a 0-10V, DALI, Ethernet, USB, WiFi, ZigBee, WiMAX, RS-232, SPI, I²C, RS-485, or GSM control input.

4. The system of claim 1, wherein the luminaire control output command is a 0-10V, DALI, Ethernet, USB, WiFi, ZigBee, WiMAX, RS-232, SPI, I²C, RS-485, or GSM output.

5. The system of claim 1, further comprising a first analog interface configured to provide one of the plurality of luminaire control inputs to the microcontroller.

6. The system of claim 1, further comprising a second analog interface configured to receive the luminaire control output command from the microcontroller.

7. The system of claim 6, further comprising a luminaire driver configured to receive the luminaire control output command from the second analog interface.

8. The system of claim 7, further comprising a relay operatively coupled to the luminaire and the microcontroller, the microcontroller further configured to control an operation of the relay to turn the luminaire on or off.

9. The system of claim 1, the microcontroller further programmed to determine a hierarchy among the plurality of luminaire control inputs and generate the luminaire control output command based on the hierarchy.

10. The system of claim 1, the microcontroller further programmed to generate a plurality of luminaire control output commands to control two or more luminaires at the same time.

11. The system of claim 1, wherein the microcontroller is further configured to receive lighting scenarios, configuration parameters, or input hierarchies from a mobile electronic device in communication with the microcontroller.

12. A method of controlling a luminaire, comprising:
receiving a plurality of luminaire control inputs at a microcontroller;
determining a desired lighting level based on one of the plurality of luminaire control inputs;
generating a luminaire control output command configured to control a luminaire driver to generate a desired lighting level; and
transmitting the luminaire control output command to the luminaire driver.

13. The method of claim 12, wherein one of the plurality of luminaire control inputs is a 0-10V, DALI, Ethernet, USB, WiFi, ZigBee, WiMAX, RS-232, SPI, I²C, RS-485, or GSM control input.

14. The method of claim 12, wherein the luminaire control output command is a 0-10V, DALI, Ethernet, USB, WiFi, ZigBee, WiMAX, RS-232, SPI, I²C, RS-485, or GSM output.

15. The method of claim 12, further comprising :
determining a hierarchy among the plurality of luminaire control inputs;
wherein the desired lighting level corresponds to a highest priority luminaire control input from the hierarchy.

16. The method of claim 15, further comprising:
receiving lighting scenarios, configuration parameters, or input hierarchies from a mobile electronic device in communication with the microcontroller;
wherein the desired lighting level is determined, at least in part, based on the lighting scenarios, configuration parameters, or input hierarchies.

17. A luminaire control system comprising:
a microcontroller configured to execute a lighting control module to:
receive a plurality of luminaire control inputs;
automatically access a user account stored in a database, the user account including customizable lighting settings;
determine a highest priority luminaire control input from the plurality of luminaire control inputs;
determine a desired lighting level based on the highest priority luminaire control input;
generate a luminaire control output command configured to control a luminaire driver to generate the desired lighting level; and
transmit the luminaire control output command to the luminaire driver.

18. The system of claim 17, wherein the microcontroller is configured to receive at least one of the plurality of luminaire control inputs from a mobile electronic device associated with the user.

19. The system of claim 18, wherein the customizable light settings in the user account are configured to be dynamically updated via the mobile electronic device.
